(19) United States
(12) Patent Application Publication
(10) Pub. No.: US 2026/0222368 A1
(43) Pub. Date: Jul. 30, 2026

(54) METHODS, APPARATUSES AND COMPUTER-READABLE MEDIUMS WITH PROGRAM CODE FOR GENERATING CONVERSATIONAL TEXT, CLASSIFYING CONVERSATIONAL TEXT, AND TRAINING A MACHINE-LEARNING MODEL

(71) Applicant: Sony Group Corporation, Tokyo (JP)

(72) Inventors: Jeroen SMEETS, Brussels (BE); Justas ZYDELIS, Brussels (BE); Katsiaryna KRASNASHCHOK, Stuttgart (DE); Pieter DAVID, Stuttgart (DE)

(73) Assignee: Sony Group Corporation, Tokyo (JP)

(21) Appl. No.: 19/146,521

(22) PCT Filed: Feb. 21, 2024
(86) PCT No.: PCT/EP2024/054419

§ 371 Date: Jul. 9, 2025

(30) Foreign Application Priority Data
Feb. 24, 2023 (EP) 23158554.8

(51) Int. Cl. H04L 51/02; G06N 20/00

(52) U.S. Cl. CPC H04L 51/02; G06N 20/00

(57) ABSTRACT

A method for generating conversational text includes training a plurality of machine-learning-based agents. In a first training phase, the agents are trained to generate text with mutually different linguistic writing styles. In a second training phase, the agents are trained based on a different objective. The first and second training phases are alternated during training. Related apparatuses, computer-readable media including program code, and training data for training a machine-learning model are also disclosed.

### FIELD

Examples relate to a method, apparatus and non-transitory, computer-readable medium comprising a program code for generating conversational text, to a method, apparatus and nontransitory, computer-readable medium comprising a program code for classifying conversational text, a method, apparatus and non-transitory, computer-readable medium comprising a program code for training a machine-learning model, and to a non-transitory, computer-readable medium comprising training data for training a machine-learning model.

### BACKGROUND

Many types of machine-learning models are trained using training data. For the training of Natural Language Processing (NLP) models, text is generally used as training data. However, in the field of NLP models for processing conversational text, an availability of conversational text data to train NLP models is limited because processing the personal data of users requires compliance with privacy regulations, e.g., according to the European Union's General Data Privacy Regulation.

One direction to overcome this lack of availability is to make use of synthetic data generation methods. For conversational data, text data can typically be generated by making use of conversational agents (chatbots) that rely on language models internally. However, text generated by conversational agents has several shortcomings. Humans usually perceive the generated text as realistic in terms of grammar and vocabulary usage but lacking a deeper meaning (the conversational agent does not understand a topic, it just has memory about a topic) and the reasoning is often deemed to be problematic. Conversational agents also tend to agree with their conversational counterpart, even if their counterpart is wrong. Conversational agents can also “hallucinate”, i.e., give incorrect information with high confidence. In general, due to the lack of actual understanding, the answers may contain physical and factual inaccuracies. It is often hard to understand what idea the agent, if any, is trying to convey. Moreover, conversational agents often give entirely different answers when the question is slightly changed. Stylistically, answers of a conversational agent often feels unnatural, lacking idioms and expression, leading to a formal and neutral style.

There may be a desire for providing an improved concept for generation of conversational text, e.g., as training data for training a machine-learning model.

### SUMMARY

This desire is addressed by the subject-matter of the independent claims.

Various examples of the present disclosure are based on the finding, that the utility of conversational agents, e.g., for the purpose of generating training data for training a NLP model, can be increased by using a two-phase training approach. To yield conversational agents with unique linguistic writing styles, the conversational agents are trained, in a first training phase, to develop mutually different linguistic writing styles, so that a less formal or neutral style can also be established. To improve other aspects of the conversational agents, such as the ability to stay on topic, the conversational are trained, in a second training phase, according to a second objective, such as the objective of staying on topic, the objective of providing useful information, or the objective of impersonating another agent. The training phases are alternated repeatedly, and result both in capable conversational agents and in generated conversational text that can, for example, be used for training an NLP machine-learning model.

Some aspects of the present disclosure relate to a method for generating conversational text. The method comprises training a plurality of machine-learning-based agents to generate conversational text. The training comprises, in a first training phase, training the plurality of machine-learning-based agents to output conversational text based on a first objective. The first objective is to develop mutually different linguistic writing styles. The training comprises, in a second training phase, training the plurality of machine-learning-based agents to output conversational text based on a second objective being different from the first objective. The first and second training phase are alternated repeatedly during training of the plurality of machine-learning-based agents. By using such two training phases, highly capable conversational agents are trained, and conversational text is generated that can, for example, be used for training an NLP machine-learning model.

For example, the plurality of machine-learning-based agents may be trained by the machine-learning-based agents providing generated conversational text to at least one of a) one or more other machine-learning-based agents of the plurality of machine-learning-based agents and b) one or more human agents. The plurality of machine-learning-based agents may be trained by the machine-learning-based agents receiving feedback from the one or more other machine-learning-based agents or one or more human agents that is based on the generated conversational text and the objective of the respective training phase. The training is performed based on the received feedback. Human agents may be used to ensure that “human-like” conversations are conducted, by both giving feedback to the machine-learning-based agents and by, through the provision of feedback, teaching the machine-learning-based agents to give feedback. Human involvement may be scaled back as the training progresses, as the agents become better at both generating the conversational text and giving feedback to the other agents.

One aim of the proposed method is the generation of conversational text. As indicated by the nomenclature, conversational text is text being used in conversation between different parties. Accordingly, the plurality of machine-learning-based agents may be trained to carry out a conversation with the one or more other machine-learning-based agents or one or more human agents.

In general, there are different conversational settings that can be used during the course of the training. For example, a conversation may be carried out between one of a) a single machine-learning-based agent and a single human agent, b) two or more machine-learning-based agents selected in a round-robin manner, and c) two or more machine-learning-based agents and one or more human agents. As outlined above, an involvement of human agents, in a one-on-one conversational setting or a group conversation, may be beneficial for the quality of the training, especially in the early phases.

In some examples, an involvement of human agents may be reduced over the course of the training. This may lead to an increased output of conversational text and/or to a reduced effort required on part of the human, as the bottleneck of requiring human involvement is reduced.

In various examples, a feedback mechanism is used for the training. For example, the feedback received may indicate one of a positive vote and a negative vote. A machine-learning-based agent may be removed from a conversation being carried out between the agents when a number of negative votes exceeds a threshold. This may weed out conversational agents that are unsuitable for the respective objective. Such agents may be discarded.

In general, there are two broad reasons for stopping a training phase—when no or little progress is made, or when the conversational setup is unsuitable for continuing training, as the number of participants has become too small. Accordingly, a training phase may be terminated when a termination condition is met. For example, the termination condition may be one of a) a target number of participants in a conversation being carried out between the machine-learning-based agents being reached and b) the feedback reaching a consensus.

There are a number of suitable objectives for the second training phases, depending on the aim being pursued with respect to the generated conversational text or with respect to the trained conversational agents. For example, the second objective may comprise at least one of a) to provide sufficiently informative conversational text, b) to carry out coherent conversation and c) to mimic a linguistic writing style of another agent. While the former two objectives are useful in many settings, the latter objective is particularly useful for the purpose of generating conversational text for training a machine-learning model to detect impersonation or for authorship verification, or for the purpose of using one or more of the agents for impersonation detection or for authorship verification.

In the proposed concept, two training phases are used to improve the capabilities of the conversational agents. In particular, these training phases may be used to train machine-learning models being used by the respective agents. For example, each agent may comprise a machine-learning model being trained to provide feedback to one or more other machine-learning-based agents. For example, the machine-learning model may be trained as classifier for classifying text according to the respective second objective. In some examples, the method may comprise providing the machine-learning model (i.e., the machine-learning model being trained as a classifier). Such a classifier may be used to classify arbitrary conversational text, e.g., for the purpose of impersonation detection or for authorship verification.

In many cases, the aim may be to generate conversational text, and/or to train conversational agents, across a wide range of topics. For example, in at least one of the training phases, a conversational topic may be randomly chosen. After a number of iterations of the two training phases, a wide range of topics may have been discussed by the conversational agents.

While a classifier may be used for the purpose of providing feedback, also the generation of the conversational text may be performed with the help of machine-learning. For example, each of the plurality of machine-learning-based agents may comprise at least one machine-learning model being trained to generate the conversational text.

In general, there is a wide range of training methodologies and techniques in the context of machine learning. One popular technique is reinforcement learning, in which one or more software agents are trained to take actions according to a policy, and in which a reward is calculated based on the policy taken. For example, training the machine-learning-based agents may comprise training the at least one machine-learning model, using reinforcement learning, to generate the conversational text. A reward of the reinforcement learning may be based on feedback of one or more human agents. Thus, the actions taken by the one or more software agents are rewarded according to the one or more human agents, leading, over time, to software agents that become better at generating the conversational text.

To further improve the “generator” machine-learning model, the respective model may learn by imitating the human agents, using supervised learning as training methodology, e.g., after the reinforcement learning-based training. For example, training the machine-learning-based agents may comprise continuing training the at least one machine-learning model, using supervised learning, to generate the conversational text, based on a plurality of utterances of the one or more human agents. This may lead to more human-like conversational text.

While the feedback of human agents can be used directly to determine the reward during the training, it may be more efficient to use the feedback of the human agents to train a reward determination machine-learning model. Accordingly, training the machine-learning-based agents may comprise training a reward determination machine-learning model to output a reward based on feedback of one or more human agents. Training the machine-learning model may comprise continuing training the at least one machine-learning model, using reinforcement learning, to generate the conversational text, with a reward of the reinforcement learning being based on the reward output by the reward determination machine-learning model. For example, after a starting phase where the feedback of the human agents is directly used, in a subsequent phase (e.g., before or after the supervised learning-based training), human involvement may be reduced by using the reward generated by the reward determination machine-learning model.

The present disclosure relates to conversational text. In a (successful) conversation, the generated text is based on the context of the conversation, which includes both the topic of the conversation and prior conversational text provided by the same or another agent. Accordingly, the at least one machine-learning model may be trained to generate the conversational text based on a conversational topic and based on prior conversational text provided by a machine-learning-based agent or a human agent.

In addition to a model being used for the generation of text, the agent may also comprise a model (the same or a different model) to provide feedback to the other agents. For example, the at least one machine-learning model may be trained to provide feedback to one or more other machine-learning-based agents. This functionality may both be used when the conversational agents are used to process arbitrary conversational text (e.g., as classifier, as outlined above), and also to enable reducing the involvement of human agents.

In some examples, two separate machine-learning models may be used. For example, each machine-learning-based agent may comprise a first machine-learning model being trained to generate the conversational text, and a separate second machine-learning model being trained to provide the feedback to the one or more other machine-learning-based agents. This may enable a separate training process for both models, and a subsequent use of either model at a reduced computational effort at least for inference during use of the trained model.

Alternatively, each machine-learning-based agent may comprise a single machine-learning model being trained to generate the conversational text and to provide the feedback to the one or more other machine-learning-based agents. This may facilitate a joint training of both aspects.

In general, the proposed concept is suitable for training conversational agents according to a wide range of different objectives. To provide adequate feedback with respect to the objective, the training of the feedback generation model takes into account the respective objective. Accordingly, the at least one machine-learning model may be trained to provide the feedback based on conversational text provided by the respective other machine-learning-based agent and based on the objective of the respective training phase.

For training the machine-learning model being trained to provide the feedback, supervised learning may be used, effectively teaching the respective model based on the feedback given by the human agent(s). For example, training the agents may comprise training, using supervised learning, the at least one machine-learning model to provide the feedback to the one or more other machine-learning-based agents. The training may be based on feedback of one or more human agents. Once the machine-learning-based agents are sufficiently adept at providing feedback themselves, the involvement of human operators may be reduced, leading to the aforementioned increased output of conversational text and/or to a reduced effort required on part of the human, as the bottleneck of requiring human involvement is reduced.

In a simple implementation, the feedback given by the respective conversational agents may be either positive or negative. Such feedback can suitably be given by training the respective model, using supervised learning, as classifier, with the classifier classifying the conversational text generated by the other agents as either good (positive) or bad (negative). In other words, the at least one machine-learning model being trained to provide feedback to the one or more other machine-learning-based agents may be trained as a classifier.

In general, other than a binary classification (positive/negative, good bad), other types of feedback may be given as well. For example, the feedback may comprise at least one of textual feedback, encoded feedback, and feedback indicated by presence or absence of a response. Such feedback may lead to a more consistent sequence of conversational text.

As outlined above, in some examples, the generated conversational text may be used to train a machine-learning model. Accordingly, the method may comprise providing the generated conversational text as training data for training a machine-learning model. For example, the training data represents a plurality of different linguistic writing styles. This may be ensured by the first training phase. Such training data, representing a wide range of different linguistic writing style, may be used to train a machine-learning model that covers a wide range of linguistic writing styles. Another aspect of the present disclosure relates to a non-transitory, computer-readable medium comprising training data for training a machine-learning model, the training data being generated as stated above.

Alternatively, or additionally, the generated conversational text may be used in entertainment, e.g., as conversations in a television show or a game. Accordingly, the method may comprise providing the generated conversational text as entertainment content. As the conversational text is provided by conversational agents with different linguistic writing styles, convincing dialogue may be generated for a wide range of scenarios.

Some aspects of the present disclosure relate to a method for classifying conversational text. The method comprises inputting the conversational text into one or more machine-learning models that are trained according to the above method. The method comprises determining a classification of the conversational text based on an output of the one or more machine-learning models. For example, the machine-learning model being trained as a classifier may be used for this purpose.

Such classification may be used in a wide range of scenarios. For example, the machine-learning model may be trained to classify the text as a) being sufficiently informative or insufficiently informative, b) being coherent or incoherent within the context of a conversation, or c) having a unique linguistic writing style or mimicking a known linguistic writing style. While the former two classification targets are primarily relevant for the purpose of evaluating the output of a machine-learning model, the third may be used for authorship attribution or impersonation detection purposes.

Some aspects of the present disclosure relate to a method for training a machine-learning model. The method comprises obtaining training data. The training data comprises a plurality of samples of generated conversational text representing a plurality of different linguistic writing styles. The training data is generated according to the above method. The method comprises using the training data to train a machine-learning model. Such a machine-learning model may be used for various NLP purposes.

An aspect of the present disclosure relates to a non-transitory, computer-readable medium comprising a program code that, when the program code may be executed on a processor, a computer, or a programmable hardware component, causes the processor, computer, or programmable hardware component to perform at least one of the above methods.

An aspect of the present disclosure relates to an apparatus comprising memory circuitry, machine-readable instructions, and processing circuitry to execute the machine-readable instructions to perform at least one of the above methods.

### BRIEF DESCRIPTION OF THE FIGURES

Some examples of apparatuses and/or methods will be described in the following by way of example only, and with reference to the accompanying figures, in which:

FIG. 1a shows a flow chart of an example of a method for generating conversational text;

FIG. 1b shows a block diagram of an example of an apparatus for generating conversational text;

FIG. 1c shows a flow chart of an example of a training of a machine-learning model for the purpose of text generation;

FIG. 1d shows a flow chart of an example of a training of a machine-learning model for the purpose of providing feedback;

FIG. 2a shows a flow chart of an example of a method for classifying conversational text;

FIG. 2b shows a block diagram of an example of an apparatus for classifying conversational text;

FIG. 3a shows a flow chart of an example of a method for training a machine-learning model; and

FIG. 3b shows a block diagram of an example of an apparatus for training a machine-learning model.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

Various examples of the present disclosure relate to a concept (e.g., method, apparatus, and program code) for generating conversational data with unique user styles, by using conversational agents in a multi-agent setup.

The proposed system may provide an improved concept for generation of text, specifically for the domain of text conversations. In this system, conversational agents are trained by interaction with each other in a multi agent setup, using multiple objectives and feedback mechanisms. The training process may include human participants that act in a similar way as the AI agents, to initialize and stabilize the training.

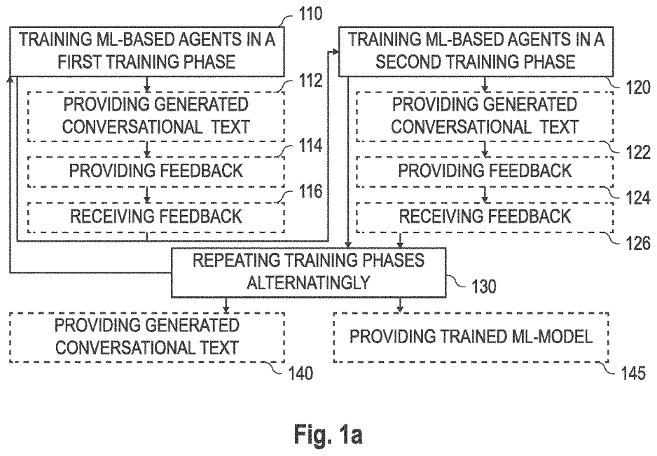

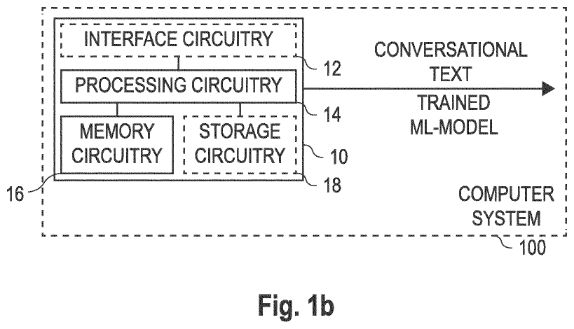

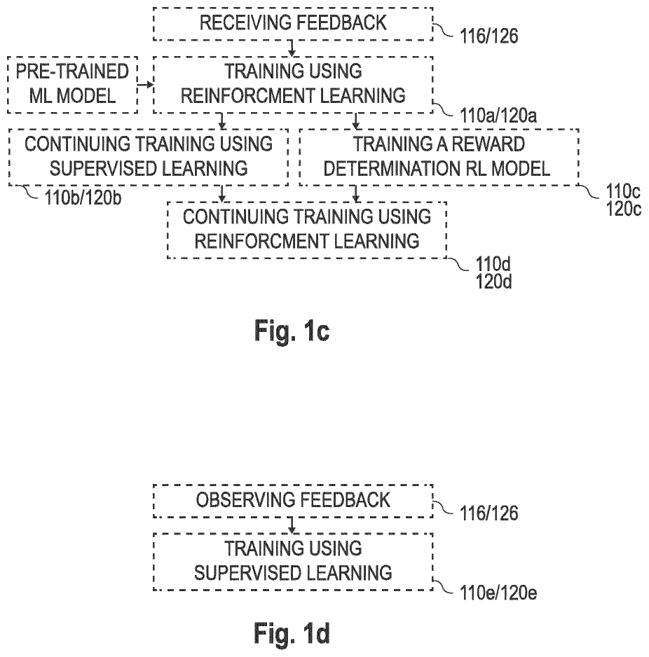

FIG. 1a shows a flow chart of an example of a method for generating conversational text. The method comprising training a plurality of machine-learning-based agents to generate conversational text. The training comprises, in a first training phase, training 110 the plurality of machine-learning-based agents to output conversational text based on a first objective. The first objective is to develop mutually different linguistic writing styles. The training comprises, in a second training phase, training 120 the plurality of machine-learning-based agents to output conversational text based on a second objective being different from the first objective. The first and second training phase are alternated repeatedly 130 during training of the plurality of machine-learning-based agents. For example, the method may be performed by a computer system, e.g., by a computer system 100 and/or apparatus 10 shown in FIG. 1b.

FIG. 1b shows a block diagram of an example of a corresponding apparatus 10 for generating conversational text, and of a computer system 100 comprising such an apparatus 10. The apparatus 10 comprises circuitry to provide the functionality of the apparatus 10. For example, the circuitry of the apparatus 10 may be configured to provide the functionality of the apparatus 10. For example, the apparatus 10 of FIG. 1b comprises (optional) interface circuitry 12, processing circuitry 14, memory circuitry 16 and (optional) storage circuitry 18. For example, the processing circuitry 14 may be coupled with the interface circuitry 12, the memory circuitry 16, and with the storage circuitry 18. For example, the processing circuitry 14 may provide the functionality of the apparatus, in conjunction with the interface circuitry 12 (for exchanging information, e.g., with other components inside or outside the computer system 100 comprising the apparatus 10, such as another computer system), the memory circuitry 16 (for temporarily storing and/or caching information) and the storage circuitry 16 (for permanently or semi-permanently storing information, such as machine-readable instructions In general, the functionality of the processing circuitry 14 may be implemented by the processing circuitry 14 executing machine-readable instructions. Accordingly, any feature ascribed to the processing circuitry 14 may be defined by one or more instructions of a plurality of machine-readable instructions. The apparatus 10 comprises the machine-readable instructions, e.g., within the memory circuitry 16 or storage circuitry 18. The processing circuitry 14 is to execute the method of FIG. 1a, e.g., by executing corresponding machine-readable instructions to perform the method.

In the following, the proposed method, apparatus, and a computer-readable medium with a computer program for generating training data is introduced in more detail in connection with the method of FIG. 1a. Features introduced in connection with the method may likewise be applied to the corresponding apparatus and computer program.

The present disclosure relates to the generation of conversational text, with the help of machine-learning-based agents. In this context, conversational text is text that is part of a conversation, e.g., a dialogue or conversation between multiple parties. As is common in conversations, the conversational text may comprise statements, questions, and responses. The conversational text may be generated by the machine-learning-based agents conversing with another, i.e., with the machine-learning-based agents providing generated conversational text to other agents and responding to the conversational text provided by other machine-learning-based agents. In addition to the machine-learning-based agents, human agents may be part of the conversation, in particular in the early stages of the training, to give valuable feedback (that can be imitated by the machine-learning-based agents) and/or to steer the conversation. Humans can vote and give feedback, similar to the feedback mechanisms of the agents. The participance of humans in the training process can gradually decrease over the course of the training when the performance of the agents is improving. In other words, an involvement of human agents may be reduced over the course of the training, e.g., once the machine-learning-based agents have developed their feedback mechanism to a degree that the feedback given by the machine-learning-based agents is sufficiently similar to the feedback given by a human agent according to a similarity criterion.

With machine-learning-based agents and human agents being involved in the conversation, there are a number of different resulting conversation settings. For example, a conversation may be carried out between a single machine-learning-based agent and a single human agent, two or more machine-learning-based agents selected in a round-robin manner, or two or more machine-learning-based agents and one or more human agents. As a result, the plurality of machine-learning-based agents may be trained to carry out a conversation with the one or more other machine-learning-based agents or one or more human agents. As a result, the conversational text may comprise messages exchanged between the plurality of machine-learning-based agents (and human agents, too).

The proposed machine-learning-based agents are used to generate the conversational text. In addition, to facilitate scalability, the machine-learning based agents may also be used to give feedback to other machine-learning-based agents, with the purpose of the machine-learning-based agents training each other by exchanging conversational text and feedback. For example, each agent may have at least one of the two following responsibilities—generation of (conversational) text, and feedback. For the purpose of generating text, the respective agent may participate in the conversation with another machine-learning-based agent or human by generating questions and responses. Accordingly, as further shown in FIG. 1a, the plurality of machine-learning-based agents may be trained by the machine-learning-based agents providing 112, 122 generated conversational text to at least one of a) one or more other machine-learning-based agents of the plurality of machine-learning-based agents and b) one or more human agents.

For the purpose of providing feedback, each agent may give positive and negative feedback on the behavior of the other participants in the conversation. Accordingly, the plurality of machine-learning-based agents may provide 114; 124 feedback (e.g., may be trained to provide feedback) to one or more other machine-learning-based agents. The feedback by the machine-learning-based agents, and additional feedback given by human agents, may then be used to train the machine-learning-based agents. In other words, the plurality of machine-learning-based agents may be trained by the machine-learning-based agents receiving 116, 126 feedback from the one or more other machine-learning-based agents or one or more human agents. This feedback is based on (prior) generated conversational text and based on an objective of the respective training phase). The training is then conducted based on the received feedback. For example, the feedback may indicate whether the generated conversational text is judged positively or negatively, prompting the machine-learning-based agent having generated the conversational text to maintain or refine a policy that led to the text (in case the feedback is positive) or to change the policy that led to the generated conversational text (in case the feedback is negative).

In general, different types of feedback mechanisms may be employed for this purpose. For example, a first feedback mechanism may rely on a voting mechanism. The agent may give both positive and negative votes to another agent participating in the conversation. An agent may have an internal classifier system that can analyze the behavior of other participants and cast votes. Other than the voting mechanism, feedback may also be given to other participants by using the reply message itself (a message with a positive or negative feedback: “Great idea” or “That doesn't make sense”) or by ending or continuing the conversation.

The proposed concept is based on the use of (at least) two training phases, which are conducted with different objectives. In the first training phase, the objective is to develop mutually different linguistic writing styles. In this context, a linguistic writing style characterizes how an agent writes, e.g., with respect to (average) sentence lengths, richness of vocabulary, mannerisms (such as typographical errors, use of capital letters for named entities or at the beginning of a sentence, use of a sequence of shorter messages vs. longer messages, use of punctuation, use of emojis, use of abbreviations, use of contractions etc.). For example, the linguistic writing style may set different agents (machine-learning-based agents and human agents) apart on a linguistic level. Thus, in the first training phase, the machine-learning-based agents are trained with the objective of developing mutually different linguistic writing styles. Further objectives for the agents can be defined, e.g., for the second training phase, depending on the desired outcome behavior of the agent after training. For example, an objective may relate to the ability to give meaningful answers. In this case, if the answers are not sufficiently informative, a negative vote can be given. Another objective may relate to the ability to stay on topic. In this case, if another participant deviates from topic, a negative vote can be given. Another objective may relate to user impersonation. In this case, if an agent detects that another participant is trying to impersonate a specific participant, a negative vote can be given. Learning to improve optimize for this objective may improve the capabilities of the agent to both generate as well as detect impersonation behavior.

Each agent may start with a common generative conversational (machine-learning) model. Training is done in two phases. In a first (training phase), the agents learn to develop unique user profiles (i.e., unique linguistic writing styles) to ensure variety and sufficient uniqueness in the communication behavior of the agents. Accordingly, in the first training phase, the method comprises training 110 the plurality of machine-learning-based agents to output conversational text based on a first objective, with the first objective being to develop mutually different linguistic writing styles. In this training phase, one-to-one conversations between a human and an agent, two agents selected in a round-robin manner or a group conversation with more than two agents including one or more human participants may be used as conversation step. Each participant (human or agent) may participate in the conversation by generating questions or replies. Objective of each agent is to create a unique user profile (i.e., a unique linguistic writing style). Each participant receives feedback from other participants, e.g., using a voting mechanism, in which profiles that are too similar to another participant receive negative votes. In other words, the feedback received may indicate one of a positive vote and a negative vote. If a participant receives too many negative votes, this participant may have to leave the conversation. In effect, a machine-learning-based agent may be removed from a conversation being carried out between the agents when a number of negative votes exceeds a threshold. For example, this machine-learning-based agent may be removed from the training and discarded. The first (training) phase may end when the voting converges, i.e., when there is agreement between the participants, conversation continues and no or enough participants are not voted out. In more general terms, a training phase may be terminated when a termination condition is met. Such a termination condition may be a target number of participants in a conversation being carried out between the machine-learning-based agents being reached (by iteratively reducing the number of participants) or the feedback reaching a consensus (i.e., if the feedback given by the remaining machine-learning-based agents and the human agent is sufficiently similar according to a similarity criterion). The outcome of the first phase is a unique synthetic user profile for each machine-learning-based agent.

In a second (training) phase, the conversation behavior is controlled by imposing a specific objective. In other words, in the second training phase, the plurality of machine-learning-based agents are trained 120 to output conversational text based on a second objective, with the second objective being different from the first objective. As outlined above, there are several different objectives that can be used in the second training phase. For example, the second objective may comprise an objective to provide sufficiently informative conversational text, an objective to carry out coherent conversation and/or an objective to mimic a linguistic writing style of another agent.

The following example describes the process for the second phase, with the objective of leading a coherent conversation about a topic. Similar to the first phase, one-to-one conversations between a human and an agent, two agents selected in a round-robin manner or a group conversation with more than two agents including one or more human participants may be used as conversation step. Multiple unique synthetic user profiles learned from the first phase are assigned to agents randomly. A conversational topic may be randomly chosen—this may also apply to the first training phase. In other words, in at least one of the training phases, a conversational topic may be randomly chosen. Similar to the first training phase, a machine-learning-based agent may be voted out if it does not follow the objective. In this particular example, a participant may be voted out of a conversation if other participants agree that it this agent does not stay on topic. In this example, the feedback that is used to train an agent is based on the votes of the other participants (with a positive vote if an agent stays on topic, and a negative vote if the agent does not stay on topic). The second phase may end when voting converges, there is agreement between participants, conversation continues, and/or no agents are voted out.

The following example describes the process for the second phase, with the objective of impersonation. Again, one-to-one conversations between a human and an agent, two agents selected in a round-robin manner or a group conversation with more than two agents including one or more human participants may be used as conversation step. Multiple unique synthetic user profiles learned from the first phase are assigned to agents randomly. One agent is randomly selected as an impersonator. This agent has the task to mimic the conversational behavior of one of the other participants. An agent may be voted out of a conversation if other participants agree that it is an imposter. In this example, the feedback that is used to train an agent is based on the votes of the other participants (with a positive vote if the agent is deemed not to be an imposter, and a negative vote if the agent is deemed to be an imposter) The second phase may end when voting converges, there is agreement between participants, conversation continues, and/or no agents are voted out.

The first and second training phase are alternated repeatedly 130 during training of the plurality of machine-learning-based agents. For example, in some cases, the same objective may be used for each iteration of the second training phase. Alternatively, different objectives may be used. Alternatively, more than two training phases may be used, with an objective being used in the third (or fourth, fifth, etc.) training phase being different from the respective objectives being used in the first and second training phases.

In the present disclosure, machine-learning-based agents are used. Machine learning refers to algorithms and statistical models that computer systems may use to perform a specific task without using explicit instructions, instead relying on models and inference. For example, in machine-learning, instead of a rule-based transformation of data, a transformation of data may be used, that is inferred from an analysis of historical and/or training data. For example, the content of images may be analyzed using a machine-learning model or using a machine-learning algorithm. In order for the machine-learning model to analyze the content of an image, the machine-learning model may be trained using training images as input and training content information as output. By training the machine-learning model with a large number of training images and associated training content information, the machine-learning model “learns” to recognize the content of the images, so the content of images that are not included of the training images can be recognized using the machine-learning model. The same principle may be used for other kinds of sensor data as well: By training a machine-learning model using training sensor data and a desired output, the machine-learning model “learns” a transformation between the sensor data and the output, which can be used to provide an output based on non-training sensor data provided to the machine-learning model.

Machine-learning models are trained using training input data. The examples specified above use a training method called “supervised learning”. In supervised learning, the machine-learning model is trained using a plurality of training samples, wherein each sample may comprise a plurality of input data values, and a plurality of desired output values, i.e., each training sample is associated with a desired output value. By specifying both training samples and desired output values, the machine-learning model “learns” which output value to provide based on an input sample that is similar to the samples provided during the training. Apart from supervised learning, semi-supervised learning may be used. In semi-supervised learning, some of the training samples lack a corresponding desired output value. Supervised learning may be based on a supervised learning algorithm, e.g., a classification algorithm, a regression algorithm or a similarity learning algorithm. Classification algorithms may be used when the outputs are restricted to a limited set of values, i.e., the input is classified to one of the limited set of values. Regression algorithms may be used when the outputs may have any numerical value (within a range). Similarity learning algorithms are similar to both classification and regression algorithms but are based on learning from examples using a similarity function that measures how similar or related two objects are.

Apart from supervised or semi-supervised learning, unsupervised learning may be used to train the machine-learning model. In unsupervised learning, (only) input data might be supplied, and an unsupervised learning algorithm may be used to find structure in the input data, e.g., by grouping or clustering the input data, finding commonalities in the data. Clustering is the assignment of input data comprising a plurality of input values into subsets (clusters) so that input values within the same cluster are similar according to one or more (pre-defined) similarity criteria, while being dissimilar to input values that are included in other clusters.

Reinforcement learning is a third group of machine-learning algorithms. In other words, reinforcement learning may be used to train the machine-learning model. In reinforcement learning, one or more software actors (called “software agents”) are trained to take actions in an environment. Based on the taken actions, a reward is calculated. Reinforcement learning is based on training the one or more software agents to choose the actions such, that the cumulative reward is increased, leading to software agents that become better at the task they are given (as evidenced by increasing rewards).

The machine-learning-based agents discussed herein have at least one of the following purposes—to generate conversational text (i.e., to carry a conversation), and to provide feedback. Both purposes may be implemented by a machine-learning model that is trained to provide the respective output. In an example implementation, each agent has two models, a generator (for generating the conversational text) and a classifier (for generating the feedback). In other words, each machine-learning-based agent may comprise a first machine-learning model being trained to generate the conversational text, and a separate second machine-learning model being trained to provide the feedback to the one or more other machine-learning-based agents. However, in some examples, a single model may be trained to provide both conversational text and feedback (e.g., if textual feedback is used, or if the machine-learning model is trained with a separate output for the feedback). In other words, each machine-learning-based agent may comprise a single machine-learning model being trained to generate the conversational text and to provide the feedback to the one or more other machine-learning-based agents.

In the following, first the text generation capabilities of the at least one machine-learning model are discussed. Each of the plurality of machine-learning-based agents may comprise at least one machine-learning model being trained to generate the conversational text. FIG. 1c shows a flow chart of an example of a training of a such a machine-learning model for the purpose of text generation. To speed up training of the machine-learning model, the training may start from a pre-trained machine-learning model, e.g., a pre-trained (large) language model. As shown in FIG. 1c, the training may use the received 116/126 feedback, and use reinforcement learning, and optionally supervised learning, to train the machine-learning model based on the feedback.

For example, training of the “generator”, i.e., the model being used to generate the conversational text, can be done using reinforcement learning from human feedback, e.g., using Ouyang et al: “Training language models to follow instructions with human feedback”. Accordingly, training the machine-learning-based agents may comprise training 110a, 120a the at least one machine-learning model (and in particular the “generator” machine-learning model), using reinforcement learning, to generate 112, 122 the conversational text. As outlined above, in reinforcement learning, one or more software actors (called “software agents”) are trained to take actions in an environment according to a policy. Based on the taken actions, a reward is calculated. Depending on the reward gained for the taken action, the policy is adjusted, with the aim of increasing the cumulative reward, leading to software agents that become better at the task they are given (as evidenced by increasing rewards). In the present context, the environment is defined by the conversational text that has been exchanged as part of the conversation and by the objective being used in the respective training phase. The policy relates to the generation of the conversational text. The reward may be calculated based on feedback provided by a human and/or the machine-learning-based agents, or, at a later stage, using a reward determination machine-learning model. In effect, the at least one machine-learning model may be trained to generate the conversational text based on a conversational topic and based on prior conversational text provided by a machine-learning-based agent or a human agent. The reward is initially calculated based on the feedback given by the one or more human agents, with positive feedback leading to a higher reward than negative feedback. To decrease reliance on human feedback over time, a reward model may be trained, e.g., using supervised training, and used to calculate the reward once no human feedback is available anymore. In other words, reward model may be trained based on feedback (votes) of the human participants. Accordingly, as further shown in FIG. 1c, training the machine-learning-based agents may comprise training 110c, 120c, e.g., using supervised learning, a reward determination machine-learning model to output a reward based on feedback of one or more human agents, and continuing training 110d, 120d the at least one machine-learning model, using reinforcement learning, to generate the conversational text. In this case, the reward of the reinforcement learning being based on the reward output by the reward determination machine-learning model. For example, the reward determination model may be trained to output the reward based on the text generated by the generator machine-learning model and/or based on the feedback given by the other machine-learning-based agents, with the reward given based on the feedback of the human agent being used as desired training output in a supervised learning-based training of the reward determination model. This reward model may be used to continue the reinforcement learning-based training, to further fine-tune the generator with reinforcement learning.

In various examples, the generator machine-learning model may be further improved based on text supplied by human participants (i.e., human agents) in the conversation. For example, the generator may be fine-tuned based on utterances of the human participants, in a supervised learning manner. Accordingly, as further shown in FIG. 1c, training the machine-learning-based agents may comprise continuing training 110b, 120b the at least one machine-learning model, using supervised learning, to generate the conversational text, based on a plurality of utterances of the one or more human agents. In this context, the utterances may be samples of text supplied by the human agents as part of the conversation between the machine-learning-based agents and the one or more human agents. For example, the human utterances may be used as desired output for the supervised learning-based training of the generator machine-learning model.

In addition to the machine-learning-based agents comprising a machine-learning model being trained to generate the conversational text, the machine-learning-based agents may comprise a machine-learning model being trained to provide the feedback. In most cases, two separate machine-learning models may be used for the two purposes. However, in some implementations, a single model may be used for both purposes.

FIG. 1d shows a flow chart of an example of a training of a machine-learning model for the purpose of providing feedback. In particular, the at least one machine-learning model may be trained to provide 114/124 (shown in FIG. 1a) feedback to one or more other machine-learning-based agents of the plurality of machine-learning-based agents. For this purpose, the at least one machine-learning model being trained to provide feedback to the one or more other machine-learning-based agents may be trained as a classifier. The classifier can be trained with supervised learning, directly from the feedback (e.g., votes) of the human participants (and, at least at later stages of the training, from the feedback of other machine-learning-based agents). Human feedback is particularly useful to start the training process. As the performance is improving, agents eventually become good enough that both human and agent feedback can be used to train other agents (agents learning from or mimicking human behavior). Finally, the use of the feedback of other machine-learning-based agents may be sufficient. Thus, training the agents may comprise training 110e, 120e, using supervised learning, the at least one machine-learning model to provide the feedback to the one or more other machine-learning-based agents, with the training being based on observed 116/126 feedback of one or more human agents and/or of one or more machine-learning-based agents and/or based on the objective of the respective training phase. For example, the supervised learning-based training of the machine-learning model may comprise using the objective (e.g., in codified form), the conversational text to be evaluated, and, optionally, prior conversational text of the conversation (e.g., if not using a Long Short-Term Memory to retain memory of the prior conversational text) as training input and the corresponding feedback of a human agent as desired training output, and training the machine-learning model based on the training input and desired training output. In effect, each agent may comprise a machine-learning model being trained to provide feedback to the one or more other machine-learning-based agents, with the machine-learning model being trained as classifier for classifying text according to the respective second objective, and with the machine-learning model being trained to provide the feedback based on conversational text provided by the respective other machine-learning-based agent and based on the objective of the respective training phase.

While FIG. 1d primarily relates to the training of a machine-learning model for the purpose of providing feedback, it may also be applied to the training of the “generator” machine-learning model, i.e., the text generation machine-learning model may be trained, starting from a pretrained machine-learning model (e.g., a (large) language model), using supervised learning, based on the received feedback (e.g., by using the feedback as label with respect to the quality of the generated text sample, or by using conversational text of human or other conversational agents as desired output). In other words, feedback may be collected (e.g. examples of human conversations or agents), and the text generation machine-learning model may be fine-tuned using supervised learning based on the feedback.

In general, the feedback can be given in various ways. In a straightforward implementation, the feedback may be given as a vote that is either positive or negative, which is a form of encoded feedback. In this case, the classifier may be trained to output a positive classification or negative classification, with the classification being output being used to cast the vote. Alternatively, the feedback may be given by providing or omitting a response, which may also be done based on the positive classification (indicating that a response is to be given) or negative classification (indicating that no response is to be given). Alternatively, the feedback may be given as textual feedback. In this case, the respective classification may be encoded as text. For example, a positive classification may be output as “Good point” or “That's interesting” in case of the objective being staying on topic and providing useful information, respectively. A negative classification may be output as “You're digressing” or “ABC already brought up that point” in case of the two objectives listed above. In summary, the feedback may comprise at least one of textual feedback, encoded feedback, and feedback indicated by presence or absence of a response. In some cases, the method may comprises translating the output of the classifier machine-learning model into corresponding feedback being provided to the other machine-learning-based agents, e.g., by encoding the classification, by translating the classification into a textual feedback, or by controlling whether a response is being provided.

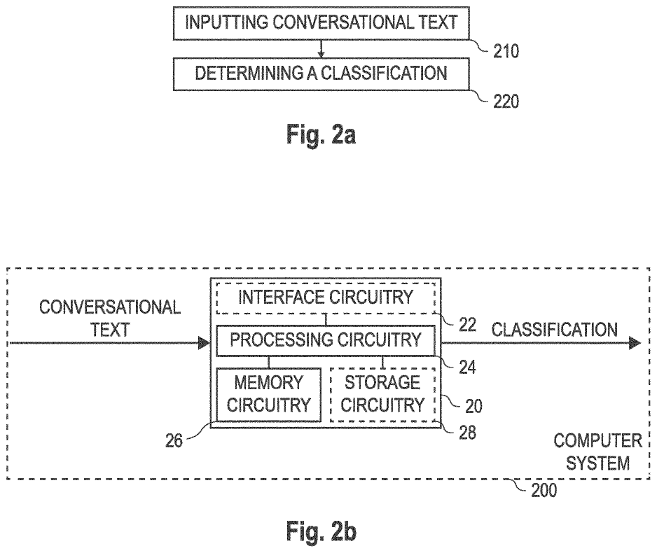

In general, the training of the machine-learning-based agents may be performed on the same computer system (e.g., computer system 100), or the training may be distributed across several different computer systems. In particular, the models for each agent can run on separate processors, devices, or nodes, which may enable training of the machine-learning-based agents, and thus also of an ensemble of classifier as discussed in connection with FIGS. 2a and 2b, in a distributed manner.

In the following, a short summary of an example of the concept being used for the purpose of text generation is given. Various examples of the present disclosure provide a system to generate synthetic text, with the system comprising a plurality of conversational agents which are trained by interaction with each other in a multi agent setup, with one or more humans participating in the conversations, using multiple objectives and feedback mechanisms.

For example, a method for training agents to improve or optimize the text generation may comprise a process comprising or consisting of two phases that are alternated repeatedly. In the first phase, agents are improved or optimized to ensure uniqueness in the conversation behavior of the agents, resulting in a set of unique generative user profiles. In the second phase, agents are improved or optimized to a specific objective to control the conversation behavior.

In both phases, one-to-one conversations may be set up between an agent and a human, two agents selected in a round-robin manner or a group conversation with more than two agents including a human. Human participation may be gradually decreased over the course of the training when the performance of the agents is improving.

In both phases, each participant may generate questions, responses or comments. A feedback mechanism may be implemented by using positive or negative votes to the other participants in the conversation. Additionally, or alternatively, the feedback mechanism may be implemented by implicitly encoding the feedback in the content of the reply message itself. Additionally, or alternatively, the feedback mechanism may be implemented by continuing or ending the conversation.

In the first phase, the participant(s) whose profile is similar to other participants may be removed using a voting mechanism in the, wherein each participant gives negative votes to participant(s) that have profile similar to itself or other participants. In the second phase, the participant(s) whose conversation behavior does not stay on topic or does not meet a specific requirement may be removed, using a voting mechanism, wherein each participant gives negative votes to participant(s) that do not meet the specific requirement.

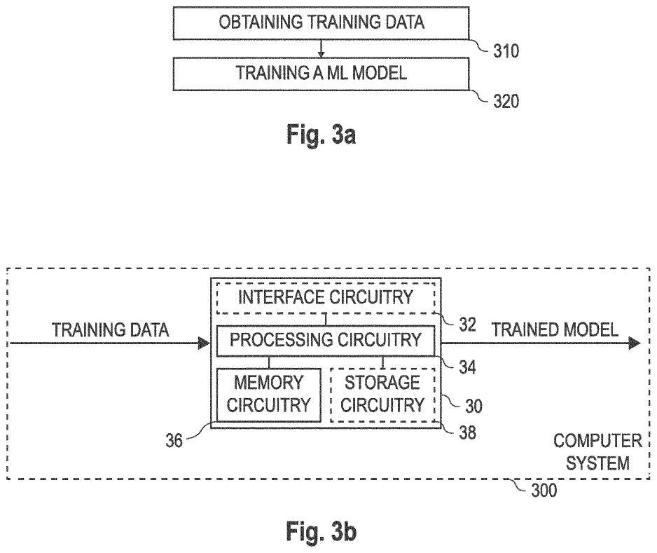

The proposed training process may provide at least one of the following outcomes. For example, the generators associated with the learned unique synthetic user profiles can be used to generate synthetic conversational data according to each unique user profile. Synthetic conversational data may be generated according to each unique user profile using the generators with the learned user profiles. For example, as further shown in FIG. 1a, the method may comprise providing the generated conversational text, e.g., via a computer-readable medium. For example, the method may comprise providing 140 the generated conversational text as training data for training a machine-learning model, with the training data representing a plurality of different linguistic writing styles (as the conversational text is generated by machine-learning-based agents being trained to develop mutually different linguistic writing styles). A use of such training data for the purpose of training a machine-learning model is shown in connection with FIGS. 3a to 3b. Additionally, or alternatively, the method may be used to generate synthetic conversations. In this case, the generated conversational data might not be used with the purpose to train a machine learning model, but to generate content, for example in games or movie scripts. Accordingly, the method may comprise providing 140 the generated conversational text as entertainment content.

Additionally, or alternatively, the classifiers of the agents can be used as an ensemble model to classify new conversations according to a specific objective, for example whether a conversation stays on topic or not. Accordingly, as further shown in FIG. 1a, the method comprising providing 145 the classifier machine-learning model. This training process enables to train an ensemble classifier in a distributed manner. Accordingly, some aspects of the present disclosure relate to a system comprising multiple apparatuses 10 (or computer systems 100) being used for training the classifier machine-learning model(s) of multiple conversational agents. In other words, models for each agent can run on separate processors/devices/nodes, which enables training of the ensemble in a distributed manner. A use of such a classifier is shown in connection with FIGS. 2a and/or 2b.

The interface circuitry 12 may correspond to one or more inputs and/or outputs for receiving and/or transmitting information, which may be in digital (bit) values according to a specified code, within a module, between modules or between modules of different entities. For example, the interface circuitry 12 may comprise circuitry configured to receive and/or transmit information.

For example, the processing circuitry 14 may be implemented using one or more processing units, one or more processing devices, any means for processing, such as a processor, a computer or a programmable hardware component being operable with accordingly adapted software. In other words, the described function of the processing circuitry 14 may as well be implemented in software, which is then executed on one or more programmable hardware components. Such hardware components may comprise a general-purpose processor, a Digital Signal Processor (DSP), a micro-controller, etc.

For example, the memory circuitry 16 may be embodied as any type of memory device capable of (temporarily) storing data, such as any type of volatile (e.g., dynamic random-access memory (DRAM), etc.) or non-volatile memory. Volatile memory may be a storage medium that requires power to maintain the state of data stored by the medium. Non-limiting examples of volatile memory may include various types of random-access memory (RAM), such as dynamic random-access memory (DRAM) or static random-access memory (SRAM). One particular type of DRAM that may be used in a memory module is synchronous dynamic random-access memory (SDRAM).

For example, the storage circuitry 18 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the method, apparatus, and computer-readable medium with a computer program for generating conversational text are mentioned in connection with the proposed concept or one or more examples described above or below (e.g., FIG. 2a to 3b). The method, apparatus, and computer program for generating conversational text may comprise one or more additional optional features corresponding to one or more aspects of the proposed concept, or one or more examples described above or below.

FIG. 2a shows a flow chart of an example of a method for classifying conversational text. The method comprises inputting 210 the conversational text into one or more machine-learning models that are trained according to the method of FIGS. 1a to 1d. The method comprises determining 220 a classification of the conversational text based on an output of the one or more machine-learning models.

FIG. 2b shows a block diagram of an example of a corresponding apparatus 20 for classifying conversational text, and of a computer system 200 comprising such an apparatus 20. The apparatus 20 comprises circuitry to provide the functionality of the apparatus 20. For example, the circuitry of the apparatus 20 may be configured to provide the functionality of the apparatus 20. For example, the apparatus 20 of FIG. 2b comprises (optional) interface circuitry 22, processing circuitry 24, memory circuitry 26 and (optional) storage circuitry 28. For example, the processing circuitry 24 may be coupled with the interface circuitry 22, the memory circuitry 26, and with the storage circuitry 28. For example, the processing circuitry 24 may provide the functionality of the apparatus, in conjunction with the interface circuitry 22 (for exchanging information, e.g., with other components inside or outside the computer system 200 comprising the apparatus 20, such as another computer system), the memory circuitry 26 (for temporarily storing and/or caching information) and the storage circuitry 26 (for permanently or semi-permanently storing information, such as machine-readable instructions In general, the functionality of the processing circuitry 24 may be implemented by the processing circuitry 24 executing machine-readable instructions. Accordingly, any feature ascribed to the processing circuitry 24 may be defined by one or more instructions of a plurality of machine-readable instructions. The apparatus 20 comprises the machine-readable instructions, e.g., within the memory circuitry 26 or storage circuitry 28. The processing circuitry 24 is to execute the method of FIG. 2a, e.g., by executing corresponding machine-readable instructions to perform the method.

In the following, the proposed method, apparatus, and a computer-readable medium with a computer program for classifying conversational text is introduced in more detail in connection with the method of FIG. 2a. Features introduced in connection with the method may likewise be applied to the corresponding apparatus and computer program.

As outlined in connection with FIGS. 1a to 1d, the machine-learning-based agents may comprise a classifier machine-learning model, which is used to determine the feedback to be provided to the other machine-learning-based agents. This trained classifier may be used, as a singular machine-learning model or as part of an ensemble of machine-learning models, to classify arbitrary conversational text according to the objective(s) being used to train the machine-learning-based agents. For example, a singular model or an ensemble model may be built to classify whether a conversation stays on topic, to determine the similarity between the conversation style of two participants, or to make a prediction whether the conversation behavior of another participant meets a specific objective, using the classifiers of each agent, or using the judgement of the human participant. For example, the ensemble model may use the output of the respective classifiers of the machine-learning-based agents, and perform “bagging” or “voting” using the outputs of the respective classifiers. In bagging, the outputs of the different classifiers are aggregated. In voting, the output that occurs most often is used.

The respective classifier or ensemble model may be used for classifying the conversational text according to the objectives being used to train the respective classifier. For example, as outlined in connection with FIGS. 1a to 1d, the one or more machine-learning models may be trained to classify the text as a) being sufficiently informative or insufficiently informative, b) being coherent or incoherent within the context of a conversation, or c) having a unique linguistic writing style or mimicking a known linguistic writing style.

In FIG. 2b a single apparatus 20 is shown, which may be used to host and run inference on one or multiple machine-learning models (i.e., the classifiers). However, in some examples, multiple apparatuses 20 (or multiple computer systems 200 with corresponding apparatuses 20) may be used to host and run inference on multiple machine-learning models, with one of the apparatuses being used to combine the results of the respective machine-learning models (e.g., using the “bagging” or “voting” outlined above). In other words, models for each agent can run on separate processors/devices/nodes, which would enable training of the ensemble in a distributed manner.

The interface circuitry 22 may correspond to one or more inputs and/or outputs for receiving and/or transmitting information, which may be in digital (bit) values according to a specified code, within a module, between modules or between modules of different entities. For example, the interface circuitry 22 may comprise circuitry configured to receive and/or transmit information.

For example, the processing circuitry 24 may be implemented using one or more processing units, one or more processing devices, any means for processing, such as a processor, a computer or a programmable hardware component being operable with accordingly adapted software. In other words, the described function of the processing circuitry 24 may as well be implemented in software, which is then executed on one or more programmable hardware components. Such hardware components may comprise a general-purpose processor, a Digital Signal Processor (DSP), a micro-controller, etc.

For example, the memory circuitry 26 may be embodied as any type of memory device capable of (temporarily) storing data, such as any type of volatile (e.g., dynamic random-access memory (DRAM), etc.) or non-volatile memory. Volatile memory may be a storage medium that requires power to maintain the state of data stored by the medium. Non-limiting examples of volatile memory may include various types of random-access memory (RAM), such as dynamic random-access memory (DRAM) or static random-access memory (SRAM). One particular type of DRAM that may be used in a memory module is synchronous dynamic random-access memory (SDRAM).

For example, the storage circuitry 28 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the method, apparatus, and computer-readable medium with a computer program for classifying conversational text are mentioned in connection with the proposed concept or one or more examples described above or below (e.g., FIG. 1a to 1d, 3a to 3b). The method, apparatus, and computer program for classifying conversational text may comprise one or more additional optional features corresponding to one or more aspects of the proposed concept, or one or more examples described above or below.

FIG. 3a shows a flow chart of an example of a method for training a machine-learning model. The method comprises obtaining 310 training data. The training data comprises a plurality of samples of generated conversational text representing a plurality of different linguistic writing styles. The training data is generated according to the method of FIGS. 1a to 1d. The method comprises training 320 the machine-learning model using the training data.

FIG. 3b shows a block diagram of an example of a corresponding apparatus 30 for training a machine-learning model, and of a computer system 300 comprising such an apparatus 30. The apparatus 30 comprises circuitry to provide the functionality of the apparatus 30. For example, the circuitry of the apparatus 30 may be configured to provide the functionality of the apparatus 30. For example, the apparatus 30 of FIG. 3b comprises (optional) interface circuitry 32, processing circuitry 34, memory circuitry 36 and (optional) storage circuitry 38. For example, the processing circuitry 34 may be coupled with the interface circuitry 32, the memory circuitry 36, and with the storage circuitry 38. For example, the processing circuitry 34 may provide the functionality of the apparatus, in conjunction with the interface circuitry 32 (for exchanging information, e.g., with other components inside or outside the computer system 300 comprising the apparatus 30, such as another computer system), the memory circuitry 36 (for temporarily storing and/or caching information) and the storage circuitry 36 (for permanently or semi-permanently storing information, such as machine-readable instructions In general, the functionality of the processing circuitry 34 may be implemented by the processing circuitry 34 executing machine-readable instructions. Accordingly, any feature ascribed to the processing circuitry 34 may be defined by one or more instructions of a plurality of machine-readable instructions. The apparatus 30 comprises the machine-readable instructions, e.g., within the memory circuitry 36 or storage circuitry 38. The processing circuitry 34 is to execute the method of FIG. 3a, e.g., by executing corresponding machine-readable instructions to perform the method.

In the following, the proposed method, apparatus, and a computer-readable medium with a computer program for training the machine-learning model is introduced in more detail in connection with the method of FIG. 3a. Features introduced in connection with the method may likewise be applied to the corresponding apparatus and computer program.

While FIGS. 1a to 1d relate to the generation of the conversational text, FIGS. 3a and 3b relate to their use for the training of a machine-learning model. The method of FIG. 3a starts by obtaining 310 the generated conversational text as training data, e.g., according to the method of FIGS. 1a to 1d. The generation of said generated conversational text has been discussed, at length, in connection with FIGS. 1a to 1d. In the proposed concept, in one approach, the generation of the conversational text, and the training of the machine-learning model may be performed by the same apparatus 10; 30 or computer system 100; 300. Thus, the methods of FIGS. 1a to 1d and 2a may be performed by the same computer system 100; 300 or apparatus 10; 30. Alternatively, however, both tasks may be performed by different computer systems or apparatuses. In other words, the conversational text may be generated by a first apparatus 10 or computer system 100 (e.g., as shown in connection with FIG. 1b) and used to train the machine-learning model by a second apparatus 30 or computer system 300. Some examples relate to a system comprising both the first and second apparatus and/or both the first and second computer system.

The training data comprises samples of conversational text according to a plurality of different writing styles. These samples of conversational text correspond to the generated conversational text discussed in connection with FIGS. 1a to 1d. They are based on a plurality of different linguistic writing styles. Such conversational text, being based on different linguistic writing styles, may be used for the training of different types of machine-learning models.

For example, generative pre-training, which comprises an unsupervised pre-training followed by supervised fine-tuning) may be used, e.g., as described by Radford et al. in “Improving Language Understanding by Generative Pre-Training”, e.g., to achieve a GPT (Generative Pre-Training) model, and in particular a GPT model that is suitable for the purpose of text generation. In other words, the machine-learning model may be trained to generate text, using generative pre-training. For example, the generated conversational text may be used for such pre-training. Additionally, or alternatively, the generated conversational text may be used for finetuning such a model, e.g., using supervised learning.

Alternatively, supervised learning may be used to train the machine-learning model to perform authorship verification (i.e., attribution) and/or impersonation detection. For example, the training data may serve as a “pretraining” set—it can result in a good startup model that can be later fine-tuned on the real data from people. For example, the machine-learning model may be trained, using supervised learning, to attribute a sample of conversational text to an author. For this purpose, the machine-learning model may be trained to transform a sample of conversational text into an embedding (e.g., a bit vector), with conversational text being based on the same linguistic writing style being transformed into the same (or at least similar) embeddings. In other words, the machine-learning model may be trained such, that samples of conversational text of the same machine-learning-based agent (and thus linguistic writing style) are transformed into the same or similar embeddings. For example, triplet loss may be used for this purpose. In triplet loss, a baseline input is compared to a positive input and a negative input. For example, during training of the machine-learning model, a first sample of conversational text generated by a first machine-learning-based agent may be compared to a second sample of conversational text generated by the first machine-learning-based agent as positive input and to a third sample of conversational text of text generated by a (different) second machine-learning-based agent as negative input. Triplet loss, and other techniques may be used, based on the training data, to train the machine-learning model.

The training introduced above may be considered an initial training, serving to generate a machine-learning model that can tell apart conversational text of different authors (or rather linguistic writing styles). This training can then be extended using sample text of “real” (i.e., not generated) authors, to train the machine-learning model for the purpose of authorship verification and/or impersonation detection. Accordingly, the machine-learning model may be trained 220 (e.g., the training may be continued so that the machine-learning model is finetuned) using a further set of conversational text of an existing author (or multiple existing authors). For example, the above-referenced triplet loss may be used to train the machine-learning model such, that samples of conversational of the existing author are transformed into the same or similar embeddings (and into embeddings that are dissimilar from the text of other authors or machine-learning-based agents). Thus, the machine-learning model may be trained to provide information on whether text input into the machine-learning model originated from the existing author. This may be done via the aforementioned embeddings, or by training the machine-learning model as a classifier, to classify whether the text input into the model originated from the existing author.

The interface circuitry 32 may correspond to one or more inputs and/or outputs for receiving and/or transmitting information, which may be in digital (bit) values according to a specified code, within a module, between modules or between modules of different entities. For example, the interface circuitry 32 may comprise circuitry configured to receive and/or transmit information.

For example, the processing circuitry 34 may be implemented using one or more processing units, one or more processing devices, any means for processing, such as a processor, a computer or a programmable hardware component being operable with accordingly adapted software. In other words, the described function of the processing circuitry 34 may as well be implemented in software, which is then executed on one or more programmable hardware components. Such hardware components may comprise a general-purpose processor, a Digital Signal Processor (DSP), a micro-controller, etc.

For example, the memory circuitry 36 may be embodied as any type of memory device capable of (temporarily) storing data, such as any type of volatile (e.g., dynamic random-access memory (DRAM), etc.) or non-volatile memory. Volatile memory may be a storage medium that requires power to maintain the state of data stored by the medium. Non-limiting examples of volatile memory may include various types of random-access memory (RAM), such as dynamic random-access memory (DRAM) or static random-access memory (SRAM). One particular type of DRAM that may be used in a memory module is synchronous dynamic random-access memory (SDRAM).

For example, the storage circuitry 38 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage. More details and aspects of the method, apparatus, and computer-readable medium with a computer program for training a machine-learning model are mentioned in connection with the proposed concept or one or more examples described above or below (e.g., FIG. 1a to 2b). The method, apparatus, and computer program for training the machine-learning-model may comprise one or more additional optional features corresponding to one or more aspects of the proposed concept, or one or more examples described above or below.

In various examples of the present disclosure, machine-learning and machine-learning models are being used. Machine-learning algorithms are usually based on a machine-learning model. In other words, the term “machine-learning algorithm” may denote a set of instructions that may be used to create, train or use a machine-learning model. The term “machine-learning model” may denote a data structure and/or set of rules that represents the learned knowledge, e.g., based on the training performed by the machine-learning algorithm. In embodiments, the usage of a machine-learning algorithm may imply the usage of an underlying machine-learning model (or of a plurality of underlying machine-learning models). The usage of a machine-learning model may imply that the machine-learning model and/or the data structure/set of rules that is the machine-learning model is trained by a machine-learning algorithm.

For example, the respective machine-learning model(s) may be artificial neural network(s) (ANN). ANNs are systems that are inspired by biological neural networks, such as can be found in a brain. ANNs comprise a plurality of interconnected nodes and a plurality of connections, so-called edges, between the nodes. There are usually three types of nodes, input nodes that receiving input values, hidden nodes that are (only) connected to other nodes, and output nodes that provide output values. Each node may represent an artificial neuron. Each edge may transmit information, from one node to another. The output of a node may be defined as a (non-linear) function of the sum of its inputs. The inputs of a node may be used in the function based on a “weight” of the edge or of the node that provides the input. The weight of nodes and/or of edges may be adjusted in the learning process. In other words, the training of an artificial neural network may comprise adjusting the weights of the nodes and/or edges of the artificial neural network, i.e., to achieve a desired output for a given input. In at least some embodiments, the machine-learning model may be deep neural network, e.g., a neural network comprising one or more layers of hidden nodes (i.e., hidden layers), preferably a plurality of layers of hidden nodes.

Alternatively, the respective machine-learning model(s) may be a support vector machine(s). Support vector machines (i.e., support vector networks) are supervised learning models with associated learning algorithms that may be used to analyze data, e.g., in classification or regression analysis. Support vector machines may be trained by providing an input with a plurality of training input values that belong to one of two categories. The support vector machine may be trained to assign a new input value to one of the two categories. Alternatively, the respective machine-learning model(s) may be Bayesian network(s), which is a probabilistic directed acyclic graphical model. A Bayesian network may represent a set of random variables and their conditional dependencies using a directed acyclic graph. Alternatively, the respective machine-learning model(s) may be based on a genetic algorithm, which is a search algorithm and heuristic technique that mimics the process of natural selection.

In the following, some examples of the proposed concept are presented:
(1) A method for generating conversational text, the method comprising:
   Training a plurality of machine-learning-based agents to generate conversational text, by:
   in a first training phase, training the plurality of machine-learning-based agents to output conversational text based on a first objective, the first objective being to develop mutually different linguistic writing styles, in a second training phase, training the plurality of machine-learning-based agents to output conversational text based on a second objective being different from the first objective,
   wherein the first and second training phase are alternated repeatedly during training of the plurality of machine-learning-based agents.
(2) The method according to (1), wherein the plurality of machine-learning-based agents are trained by the machine-learning-based agents providing generated conversational text to at least one of a) one or more other machine-learning-based agents of the plurality of machine-learning-based agents and b) one or more human agents, and by the machine-learning-based agents receiving feedback from the one or more other machine-learning-based agents or one or more human agents that is based on the generated conversational text and the objective of the respective training phase, with the training being based on the received feedback.
(3) The method according to (2), wherein the plurality of machine-learning-based agents are trained to carry out a conversation with the one or more other machine-learning-based agents or one or more human agents.
(4) The method according to (3) wherein a conversation is carried out between one of a) a single machine-learning-based agent and a single human agent, b) two or more machine-learning-based agents selected in a round-robin manner, and c) two or more machine-learning-based agents and one or more human agents.
(5) The method according to (4), wherein an involvement of human agents is reduced over the course of the training.
(6) The method according to one of (2) to (5), wherein the feedback received indicates one of a positive vote and a negative vote, with a machine-learning-based agent being removed from a conversation being carried out between the agents when a number of negative votes exceeds a threshold.
(7) The method according to one of (2) to (6), wherein a training phase is terminated when a termination condition is met, the termination condition being one of a) a target number of participants in a conversation being carried out between the machine-learning-based agents being reached and b) the feedback reaching a consensus.
(8) The method according to one of (1) to (7), wherein the second objective comprises at least one of a) to provide sufficiently informative conversational text, b) to carry out coherent conversation and c) to mimic a linguistic writing style of another agent.
(9) The method according to one of (1) to (8), wherein each agent comprises a machine-learning model being trained to provide feedback to one or more other machine-learning-based agents, the machine-learning model being trained as classifier for classifying text according to the respective second objective, the method comprising providing the machine-learning model.
(10) The method according to one of (1) to (9), wherein in at least one of the training phases, a conversational topic is randomly chosen.
(11) The method according to one of (1) to (10), wherein each of the plurality of machine-learning-based agents comprises at least one machine-learning model being trained to generate the conversational text.
(12) The method according to (11), wherein training the machine-learning-based agents comprises training the at least one machine-learning model, using reinforcement learning, to generate the conversational text, with a reward of the reinforcement learning being based on feedback of one or more human agents.
(13) The method according to (12), wherein training the machine-learning-based agents comprises continuing training the at least one machine-learning model, using supervised learning, to generate the conversational text, based on a plurality of utterances of the one or more human agents.
(14) The method according to one of (12) or (13), wherein training the machine-learning-based agents comprises training a reward determination machine-learning model to output a reward based on feedback of one or more human agents, and continuing training the at least one machine-learning model, using reinforcement learning, to generate the conversational text, with a reward of the reinforcement learning being based on the reward output by the reward determination machine-learning model.
(15) The method according to one of (11) to (14), wherein the at least one machine-learning model is trained to generate the conversational text based on a conversational topic and based on prior conversational text provided by a machine-learning-based agent or a human agent.
(16) The method according to one of (11) to (15), wherein the at least one machine-learning model is trained to provide feedback to one or more other machine-learning-based agents.
(17) The method according to (16), wherein each machine-learning-based agent comprises a first machine-learning model being trained to generate the conversational text, and a separate second machine-learning model being trained to provide the feedback to the one or more other machine-learning-based agents.
(18) The method according to (16), wherein each machine-learning-based agent comprises a single machine-learning model being trained to generate the conversational text and to provide the feedback to the one or more other machine-learning-based agents.
(19) The method according to one of (16) to (18), wherein the at least one machine-learning model is trained to provide the feedback based on conversational text provided by the respective other machine-learning-based agent and based on the objective of the respective training phase.
(20) The method according to one of (16) to (19), wherein training the agents comprises training, using supervised learning, the at least one machine-learning model to provide the feedback to the one or more other machine-learning-based agents, with the training being based on feedback of one or more human agents and/or based on feedback of one or more other machine-learning-based agents.
(21) The method according to (20), wherein the at least one machine-learning model being trained to provide feedback to the one or more other machine-learning-based agents is trained as a classifier.
(22) The method according to one of (16) to (21), wherein the feedback comprises at least one of textual feedback, encoded feedback, and feedback indicated by presence or absence of a response.
(23) The method according to one of (1) to (22), comprising providing the generated conversational text as training data for training a machine-learning model, the training data representing a plurality of different linguistic writing styles.
(24) The method according to one of (1) to (23), comprising providing the generated conversational text as entertainment content.
(25) A non-transitory, computer-readable medium comprising training data for training a machine-learning model, the training data being generated according to the method of (23).
(26) A method for classifying conversational text, the method comprising:
   Inputting the conversational text into one or more machine-learning models that are trained according to the method of (9); and
   Determining a classification of the conversational text based on an output of the one or more machine-learning models.
(27) The method according to (26), wherein the machine-learning model is trained to classify the text as a) being sufficiently informative or insufficiently informative, b) being coherent or incoherent within the context of a conversation, or c) having a unique linguistic writing style or mimicking a known linguistic writing style.
(28) A method for training a machine-learning model, the method comprising:
   obtaining training data, the training data comprising a plurality of samples of generated conversational text representing a plurality of different linguistic writing styles, the training data being generated according to the method of (23); and
   using the training data to train a machine-learning model.
(29) A non-transitory, computer-readable medium comprising a program code that, when the program code is executed on a processor, a computer, or a programmable hardware component, causes the processor, computer, or programmable hardware component to perform the method of one of (1) to (24), or the method of one of (26) or (27), or the method of (28).
(30) An apparatus comprising memory circuitry, machine-readable instructions, and processing circuitry to execute the machine-readable instructions to perform the method of one of (1) to (24), or the method of one of (26) or (27), or the method of (28).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A method for generating conversational text, the method comprising:
Training a plurality of machine-learning-based agents to generate conversational text, by:
in a first training phase, training the plurality of machine-learning-based agents to output conversational text based on a first objective, the first objective being to develop mutually different linguistic writing styles,
in a second training phase, training the plurality of machine-learning-based agents to output conversational text based on a second objective being different from the first objective,
wherein the first and second training phase are alternated repeatedly during training of the plurality of machine-learning-based agents.

2. The method according to claim 1, wherein the plurality of machine-learning-based agents are trained by the machine-learning-based agents providing generated conversational text to at least one of a) one or more other machine-learning-based agents of the plurality of machine-learning-based agents and b) one or more human agents, and by the machine-learning-based agents receiving feedback from the one or more other machine-learning-based agents or one or more human agents that is based on the generated conversational text and the objective of the respective training phase, with the training being based on the received feedback.

3. The method according to claim 2, wherein the plurality of machine-learning-based agents are trained to carry out a conversation with the one or more other machine-learning-based agents or one or more human agents.

4. The method according to claim 3, wherein a conversation is carried out between one of a) a single machine-learning-based agent and a single human agent, b) two or more machine-learning-based agents selected in a round-robin manner, and c) two or more machine-learning-based agents and one or more human agents.

5. The method according to claim 2, wherein a training phase is terminated when a termination condition is met, the termination condition being one of a) a target number of participants in a conversation being carried out between the machine-learning-based agents being reached and b) the feedback reaching a consensus.

6. The method according to claim 1, wherein the second objective comprises at least one of a) to provide sufficiently informative conversational text, b) to carry out coherent conversation and c) to mimic a linguistic writing style of another agent.

7. The method according to claim 1, wherein each of the plurality of machine-learning-based agents comprises at least one machine-learning model being trained to generate the conversational text.

8. The method according to claim 7, wherein training the machine-learning-based agents comprises training the at least one machine-learning model, using reinforcement learning, to generate the conversational text, with a reward of the reinforcement learning being based on feedback of one or more human agents.

9. The method according to claim 8, wherein training the machine-learning-based agents comprises continuing training the at least one machine-learning model, using supervised learning, to generate the conversational text, based on a plurality of utterances of the one or more human agents.

10. The method according to claim 8, wherein training the machine-learning-based agents comprises training a reward determination machine-learning model to output a reward based on feedback of one or more human agents and continuing training the at least one machine-learning model, using reinforcement learning, to generate the conversational text, with a reward of the reinforcement learning being based on the reward output by the reward determination machine-learning model.

11. The method according to claim 7, wherein the at least one machine-learning model is trained to generate the conversational text based on a conversational topic and based on prior conversational text provided by a machine-learning-based agent or a human agent.

12. The method according to claim 7, wherein the at least one machine-learning model is trained to provide feedback to one or more other machine-learning-based agents.

13. The method according to claim 12, wherein the at least one machine-learning model is trained to provide the feedback based on conversational text provided by the respective other machine-learning-based agent and based on the objective of the respective training phase.

14. The method according to claim 1, comprising providing the generated conversational text as training data for training a machine-learning model, the training data representing a plurality of different linguistic writing styles, or providing the generated conversational text as entertainment content.

15. The method according to claim 1, wherein each agent comprises a machine-learning model being trained to provide feedback to one or more other machine-learning-based agents, the machine-learning model being trained as classifier for classifying text according to the respective second objective, the method comprising providing the machine-learning model.

16. A non-transitory, computer-readable medium comprising training data for training a machine-learning model, the training data being generated according to the method of claim 15.

17. A method for classifying conversational text, the method comprising:
Inputting the conversational text into one or more machine-learning models that are trained according to the method of claim 16; and
Determining a classification of the conversational text based on an output of the one or more machine-learning models.

18. A method for training a machine-learning model, the method comprising:
obtaining training data, the training data comprising a plurality of samples of generated conversational text representing a plurality of different linguistic writing styles, the training data being generated according to the method of claim 15; and
using the training data to train a machine-learning model.

19. A non-transitory, computer-readable medium comprising a program code that, when the program code is executed on a processor, a computer, or a programmable hardware component, causes the processor, computer, or programmable hardware component to perform the method of claim 1, or the method of claim 17, or the method of claim 18.

20. An apparatus comprising memory circuitry, machine-readable instructions, and processing circuitry to execute the machine-readable instructions to perform the method of claim 1, or the method of claim 17, or the method of claim 18.
